(19) United States
(12) Patent Application Publication
(10) Pub. No.: US 2012/0286031 A1
(43) Pub. Date: Nov. 15, 2012

(54) SYMBOLOGY FOR UNIFIED BARCODE

(75) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/561,521

(22) Filed: Jul. 30, 2012

(51) Int. Cl. G06K 19/06; G06F 17/30

(52) U.S. Cl. 235/375; 235/494

(57) ABSTRACT

A method and system for encoding symbols to be placed on a label of a product or apparatus are disclosed. According to one aspect, a method for creating a unified symbology is provided that includes combining a first encoded symbol with a second encoded symbol to produce a third encoded symbol. The third encoded symbol is associated with first data that is associated with the first encoded symbol and with second data that is associated with the second encoded symbol.

### FIELD OF THE INVENTION

The present invention relates to symbology, and more particularly to multifunctional symbology in the form of information encoded onto a label.

### BACKGROUND OF THE INVENTION

A barcode is an optical machine-readable representation of data relating to the object to which it corresponds. Originally barcodes, such as the uniform product code (UPC), represented data by varying the width and spacing of parallel lines, and may be referred to as linear or one-dimensional (1D). An example of a one-dimensional barcode is shown in FIG. 1. Two dimensional codes, such as the quick response (QR) codes have also been developed. An example of a QR code is shown in FIG. 2.

Linear barcodes such as the UPC have become a ubiquitous element of modern civilization, as evidenced by their enthusiastic adoption by stores around the world; almost every item from a grocery store, department store, and mass merchandiser has a UPC barcode on it. This helps track items and also reduces instances of shoplifting involving price tag swapping, although shoplifters can now print their own barcodes. In addition, retail chain membership cards (issued mostly by grocery stores and specialty “big box” retail stores such as sporting equipment, office supply, or pet stores) use barcodes to uniquely identify consumers, allowing for customized marketing and greater understanding of individual consumer shopping patterns.

Barcodes can allow for the organization of large amounts of data. They are widely used in the healthcare and hospital settings, ranging from patient identification (to access patient data, including medical history, drug allergies, etc.) to medication management. They are also used to facilitate the separation and indexing of documents that have been imaged in batch scanning applications, track the organization of species in biology, and integrate with in-motion check weighing systems to identify the item being weighed in a conveyor line for data collection.

Barcodes can also be used to keep track of objects and people; they are used to keep track of rental cars, airline luggage, nuclear waste, registered mail, express mail and parcels. Barcoded tickets allow the holder to enter sports arenas, cinemas, theatres, fairgrounds, and transportation, and are used to record the arrival and departure of vehicles from rental facilities etc. This can allow proprietors to identify duplicate or fraudulent tickets more easily. Barcodes are widely used in shop floor control applications software where employees can scan work orders and track the time spent on a job. A disadvantage of the UPC barcodes is that the total number of items that may be represented is limited.

QR codes were first designed for the automotive industry. More recently, the system has become popular outside the automotive industry due to its fast and accurate readability and large storage capacity compared to standard UPC barcodes. The code consists of black modules (square dots) arranged in a square pattern on a white background. Unlike the 1-dimensional UPC barcode that was designed to be mechanically scanned by a narrow beam of light, the QR code is detected as a 2-dimensional digital image by a semiconductor image sensor and is then digitally analyzed by a programmed processor. The processor locates the three distinctive squares at the corners of the image, and normalizes image size, orientation, and angle of viewing, with the aid of a smaller square near the fourth corner. The small dots are then converted to binary numbers and validity checked with an error-correcting code.

Although initially used to track parts in vehicle manufacturing, QR Codes are now used over a much wider range of applications, including commercial tracking, entertainment and transport ticketing, and product coupons. QR codes may encode a Uniform Resource Locator (URL) which addresses a website on the Internet.

A QR code or a UPC code may be decoded using a decoder which may be a mobile app. Thus, mobile apps that decode UPC and QR codes may be installed in a mobile phone, allowing a mobile phone user to scan and interpret a barcode or QR code.

As noted, a UPC is limited in the quantity of data that can be encoded. This is a disadvantage of UPC codes. An advantage of QR codes is that scanners for detecting and decoding them are simpler than for the scanner and processor required to detect and decode a UPC code. Further, QR codes can store much more information than a UPC. Many items have both a QR code and a UPC, where each code represents different information in which the codes are attached to the item or affixed on a label of the item in separate locations. Having two separately located codes consumes valuable space on a package label that could be used for other information and graphics. Further, printing two symbology codes on an item is not visually appealing and can also confuse the retail clerk assigned to scan the symbologies since they frequently do not know which symbology to scan. Further, the package must be handled to orient each code on the package to be read by a corresponding code reader. Thus, the package must be held in a first position to read a first code, and held in a second position to read the second code.

### SUMMARY OF THE INVENTION

The present invention advantageously provides a method and system for encoding symbols to be placed on a label of an item, product or apparatus. According to one aspect, a method for creating a unified symbology is provided that includes combining a first encoded symbol with a second encoded symbol to produce a third encoded symbol. The third encoded symbol is associated with first data that is associated with the first encoded symbol and with second data that is associated with the second encoded symbol.

According to another aspect, the invention provides a composite symbol that is a combination of at least parts of at least two symbols. The composite symbol has a first symbol component having first data encoded according to a first algorithm. The composite symbol also has a second symbol component having second data encoded according to one of the first algorithm and a second algorithm.

According to another aspect, a system for creating a composite symbol corresponding to data about an item is provided. The system includes a memory and a processor. The memory is configured to store data corresponding to the item. The processor translates at least some of the data to a first symbol component according to a first algorithm. The processor also translates at least some of the data to a second symbol component according to one of the first algorithm and a second algorithm.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a known 1-dimensional barcode;

FIG. 2 is a known 2-dimensional barcode;

FIG. 3 is a one embodiment of a unified barcode formed according to principles of the present invention;

FIG. 4 is a diagram of a products on a shelf labeled with a composite symbol and with the composite symbol also attached to the shelf;

FIG. 5 is a block diagram of an exemplary system for generating, scanning, encoding and decoding a composite symbol according to principles of the present invention; and

FIG. 6 is a flowchart of an exemplary process for creating a composite symbol.

### DETAILED DESCRIPTION OF THE INVENTION

Before describing in detail exemplary embodiments that are in accordance with the present invention, it is noted that the embodiments reside primarily in combinations of apparatus components and processing steps related creating and using a unified composite symbol barcode. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

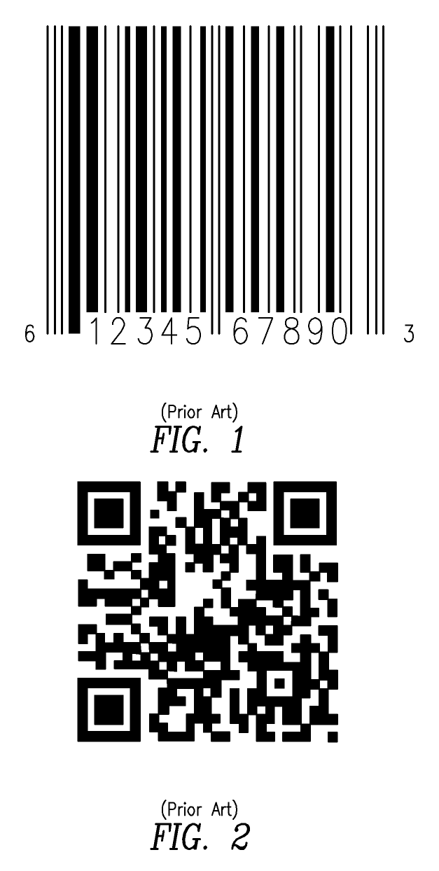

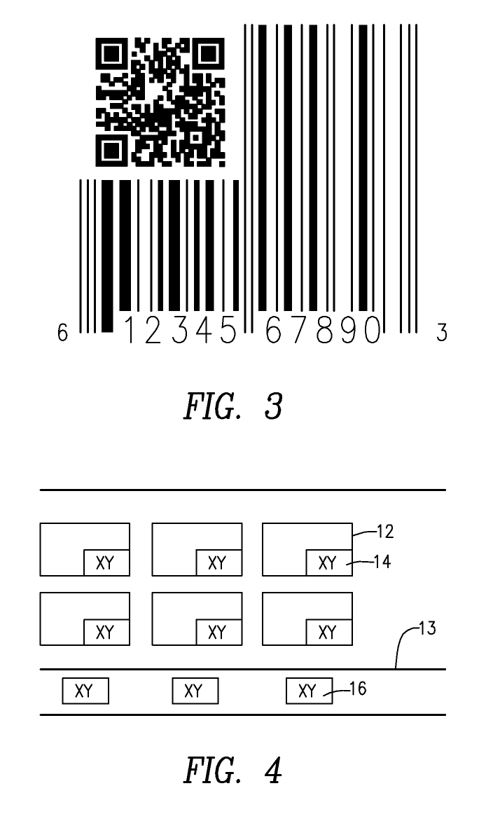

Referring now to the drawing figures, in which like reference designators denote like elements, there is shown in FIG. 3 a composite unified symbology constructed according to principles of the present invention. In particular, the symbology of FIG. 3 is based on the UPC barcode of FIG. 1 and the QR code of FIG. 2. Although, a combination of a UPC barcode and QR code are shown in FIG. 3, it will be understood that the present invention is not limited to a these two codes, as other codes may be integrated to produce a composite symbol as well. Thus, at least one one-dimensional symbol may be combined with at least one two-dimensional symbol, two or more one dimensional symbols may be combined, or two or more two-dimensional symbols may be combined. Further, the position of the QR symbol with respect to the UPC barcode may be varied and may indicate information about the product to which the label is applied.

The unified symbology of FIG. 3 may encode data associated with the UPC barcode and may encode data associated with the QR code. The data associated with the UPC barcode may be the same or different from the data associated with the QR code. In one embodiment, the data associated with the UPC barcode may be encoded according to a first algorithm and the data associated with the QR code may be encoded according to a second algorithm. Conversely, the UPC barcode may be decoded according to a first algorithm and the QR code may be decoded according to a second algorithm. For example, the data associated with the UPC barcode may be of a first category of data, such as price and product name, whereas the data associated with the QR code may be of a second category of data such as product features, which may include quantity, volume, size, weight, color, odor, flavor, date of manufacture and expiration date. It is also contemplated that a single algorithm can be used to create the unified symbology where at least a portion of the symbology represents a one-dimensional code and at least another portion represents a two-dimensional code.

Note that the composite symbol provides a reference symbol—in this case, the rectangles of the QR code—used to orient a scanning device to read the symbol. In one embodiment, the position of the QR code relative to the position of the UPC barcode may indicate information about a product to which the composite symbol is affixed, and/or may indicate an algorithm to use to decode the composite symbol. Thus, by combining the QR code and the UPC code into a single unified symbology, a package to which the composite symbol is attached, need only be positioned in a single position to read the composite symbol or to read each component—UPC and QR code—separately.

Thus, one embodiment includes a QR code overlaying a UPC. In one embodiment, a single scanner may be employed to read the composite symbol, and two different algorithms may be employed to separately decode the two components of the composite symbol. As noted above, in another embodiment, the combined UPC/QR symbol may contain data encoded by a single algorithm that translates the data to the unified symbol, as shown in FIG. 3. It is also contemplated that a single algorithm may be used to decode the composite symbol or the portion of the symbol corresponding to the reader used to acquire that portion of the unified symbol.

Thus, for example, a reference symbol embedded in the composite symbol may indicate an algorithm or methodology for decoding the symbol. As another example, the position of a reference symbol in the composite symbol may indicate an item of information or indicate an algorithm for decoding the composite symbol. As yet another example, an orientation such as a rotation of a reference symbol in the composite symbol may indicate information about an item, the item being of an object, a transaction, and a living being, or may indicate an algorithm for decoding the symbol.

FIG. 4 is a diagram of products 12 on a shelf 13. The products, i.e., articles of commerce, 12 are labeled with a composite symbol 14. In one embodiment, the composite symbol 14 may be printed on the article of commerce. The composite symbol 16 is also attached to the shelf. By combining the symbols denoted by X and Y, less area of the label is consumed by the composite global symbol. Thus, both components X and Y of the composite symbol are visible and accessible by one or more symbol readers.

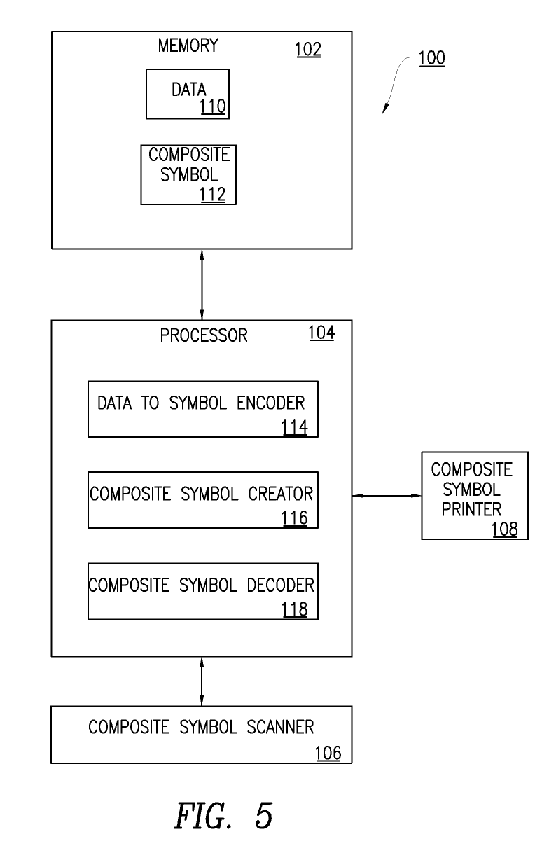

FIG. 5 is a block diagram of an exemplary system 100 for generating, scanning, encoding and decoding a composite symbol according to principles of the present invention. The system 100 includes a memory 102, a processor 104, a composite symbol scanner 106 and a composite symbol printer 108. The memory 102 stores data 110 and a composite symbol 112. Although, only one composite symbol is shown, more than one composite symbol may be stored in the memory 102. In one embodiment, the data 110 concerns an item, which may include a transaction. The term transaction may include a set of facts and circumstances, as well as a financial dealing between individuals and/or entities.

The processor 104 includes a data to symbol encoder 114 to encode at least a portion of the data 110 to produce a first symbol component and a second symbol component to form the composite symbol. A composite symbol creator 116 of the processor 104 forms a composite symbol 112 based on the first symbol component and the second symbol component. The composite symbol 112 may be printed onto a label or other item by the composite symbol printer 108. The processor 104 may also include a composite symbol decoder 118 to decode a symbol detected by the composite symbol scanner 106.

In one embodiment, the composite symbol created by the composite symbol creator 116 is a combination of at least parts of the first and second symbol components. For example, one symbol component may overlay a portion of the other symbol component, as is shown in FIG. 3. The orientation of the first symbol component and the second symbol component may provide information about an item to be labeled with the composite symbol 112. The composite symbol 112 may include a reference symbol to orient a reader of the composite symbol 112. Alternatively, or in addition, the position or orientation of the reference symbol may indicate a particular method for decoding the composite symbol 112.

Thus, in some embodiments, the composite symbol 112 may be the sum or difference of at least two separate codes, a product of at least two separate codes, a ratio of at least two separate codes, a correlation of at least two separate codes, or a convolution of at least two separate codes. The composite symbol 112 may be the result of encoding at least one set of data according to at least one algorithm. In some embodiments, the composite symbol 112 may be formed by first combining the data of at least two different data sets and applying an algorithm to the combined data to produce a composite symbol. In other embodiments, a separate algorithm is applied to each of the at least two data sets to produce a plurality of symbol patterns that are then combined to form the composite symbol 112.

Note that the various components of the system 100 may be separate in some embodiments. Thus, a composite symbol reader may be one device, whereas a composite symbol creator may be another device separate from the reader. Similarly, a database such as included in the memory 102 may be separate from the processor 104. For example, data 110 may be in a first location, the symbol creator 116 can be in a second location, the symbol printer 108 may be in a third location, and the symbol scanner 106 may be in a fourth location.

By combining separate codes into a single unified symbology, more information can be represented using less area of a product package, while allowing different vendors using different readers to scan and decode information represented by the separate codes. Thus, for example, in the case of a combination of a UPC barcode and a QR code, a grocer may employ a UPC barcode reader to read the information encoded by the UPC barcode, whereas a mobile phone user could use his or her mobile phone to read the QR code by simply looking for the composite symbol as opposed to having to identify the specific code corresponding to the specific symbology reader technology being used at the retail location. In another embodiment of the invention both symbologies could be simultaneously imaged by a mobile device, then resolved by the mobile device, and the information related to the symbologies displayed on the mobile device.

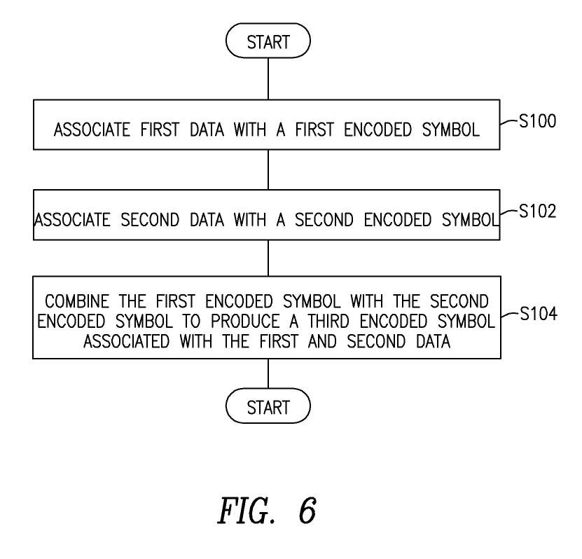

FIG. 6 is a flowchart of an exemplary process for creating a composite symbol. First data is associated with a first encoded symbol (step S100). Second data is associated with a second encoded symbol (step S102). The first encoded symbol and the second encoded symbol are combined to produce a third encoded symbol associated with the first and second data (step S104).

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for creating a unified symbology, the method comprising:
combining a first encoded symbol with a second encoded symbol to produce a third encoded symbol, the third encoded symbol being associated with first data associated with the first encoded symbol and with second data associated with the second encoded symbol.

2. The method of claim 1, wherein the first encoded symbol encodes data associated therewith according to a first encoding algorithm, and wherein the second encoded symbol encodes data associated therewith according to a second encoding algorithm.

3. The method of claim 1, wherein the first encoded symbol is decodable according to a first algorithm and the second encoded symbol is decodable according to a second algorithm.

4. The method of claim 1, wherein the data associated with the first encoded symbol is one of a first category of data and the data associated with the second encoded symbol is one of a second category of data, different from the first category of data.

5. The method of claim 4, wherein the first category is product features, and the second category is product pricing information.

6. The method of claim 5, wherein product features include at least one of quantity, volume, size, weight, color, odor, flavor, date of manufacture, and expiration date.

7. The method of claim 1, further comprising printing the third encoded symbol on an article of commerce.

8. The method of claim 1, further comprising providing within the third encoded symbol a reference symbol to orient a reading device to read the first and second encoded symbol.

9. The method of claim 8, wherein the reference symbol is a rectangle at an edge of the third encoded symbol.

10. The method of claim 1, wherein the first encoded symbol is overlaid on the second encoded symbol.

11. The method of claim 1, further comprising:
scanning the third encoded symbol;
resolving the third encoded symbol to obtain the first and second data associated with the first and second encoded symbols; and
displaying information based on the obtained data on a mobile device.

12. A composite symbol, the composite symbol being a combination of at least parts of at least two symbols, the composite symbol comprising:
a first symbol component having first data encoded according to a first algorithm; and
a second symbol component having second data encoded according to one of the first algorithm and a second algorithm.

13. The composite symbol of claim 12, wherein the first data and the second data are the same.

14. The composite symbol of claim 12, wherein the first symbol component is a one-dimensional symbol, and the second symbol component is a two-dimensional symbol.

15. The composite symbol of claim 12, wherein at least one of the first and second symbol components includes a reference symbol to orient a reader of the composite symbol.

16. The composite symbol of claim 15, wherein a position of the reference symbol determines a method for decoding the composite symbol.

17. The composite symbol of claim 12, wherein a position of the first symbol component with respect to the second symbol component provides information about an item to which the composite symbol is affixed.

18. A system for creating a composite symbol corresponding to data about an item, the system comprising:
a memory, the memory configured to store:
data corresponding to the item; and
a processor, the processor configured to:
translate at least some of the data to a first symbol component of a composite symbol according to a first algorithm; and
translate at least some of the data to a second symbol component of the composite symbol according to one of the first algorithm and a second algorithm.

19. The system of claim 18, wherein the processor is further configured to form the composite symbol from the first and second symbol components.

20. The system of claim 19, wherein an orientation of the first symbol component with respect to the second symbol component in the composite symbol provides information concerning the item.

21. The system of claim 18, wherein the formed symbol is formed by overlaying the first symbol component onto the second symbol component.

22. The system of claim 18, wherein the first algorithm is for encoding data into a uniform product code (UPC) and the second algorithm is for encoding data into a quick response (QR) code.
